(19) United States
(12) Patent Application Publication
(10) Pub. No.: US 2005/0061912 A1
(43) Pub. Date: Mar. 24, 2005

(54) "Dream of life" - system which gurantee safety flights for all type aircrafts

(76) Inventor: Ifim I. Postel, Brooklyn, NY (US)

Correspondence Address: IFIM I. POSTEL, 8224 Bay Parkway #5J, BROOKLYN, NY, 11214, US

(21) Appl. No.: 10/666,779

(22) Filed: Sep. 22, 2003

(51) Int. Cl. B64D 11/00

(52) U.S. Cl. 244/118.5

(57) ABSTRACT

The switch-key device for System “DREAM OF LIFE” comprises in combination Part A—stationary and Part B—movable, Part B have a conductor for all contact group to the Part A, control Lights and switch, which for activating and de-activating of helms thereby preventing the hijackers and unauthorized operation of the aircraft with people on the board and preventing all terrorism

3 VIDEO CAMERAS. The video cameras installed: two in Main cockpit, one outside of cockpit and directed into cockpit, the second cockpit have video camera, different from Main cockpit an emergency radio frequency to be a connected with a Government guard or special security

### 1. FIELD OF THE INVENTION

The present invention relates generally to second cockpit and switch key devices which could be installed in the tail of airplane. This device prevents any hijackers. This system shut off power so helm could not move left-right or up-down.

### 2. DESCRIPTION OF PRIOR ART

System “DREAM OF LIFE” is effective against hijackers. This system should be installed in every airplane and could save many passenger's and crew of pilot's life. The system installed in a second cockpit in the tail secure part of aircraft body.

This system can prevent any of ventures from hijackers:
To force crew of pilots to change course;
To take passengers as a hostages;
They threaten to explode or something else.
   In these situation hijackers in cockpit make all changes what hijackers want, or control for the Pilot action to change the course, all implements will show all proposes and new directions. At the same time this action is visible in second cockpit system “DREAM OF LIFE” and the airplane continue right course or ask for emergency landing by pilot located in second cockpit. Before airplane make a landing hijackers do not know anything about it, they think that airplane goes in their direction. We also can prevent destruction of strategic objects and buildings.

### 3. EXAMPLE OF KNOWN

The System Devices are disclosed in U.S. Pat. No. 3,633,851, inventor Egon Marte, issued Jan. 11, 1972 U.S. Pat. No. 5,742,336, inventor Frederick Lee, issued Apr. 21, 1996 U.S. Pat. No. 5,875,997, inventor Naser Al-Sabah, issued Mar. 2, 1999

### 4. SUMMARY OF THE INVENTION

It is a primary object of the present invention to provide the System “DREAM OF LIFE” for all aircrafts, for all sizes big or small. This invention is reliable and simple in manufacturing.

It is a further object of the presented invention to be a very important to guarantee safe flying.

With a view to attaining the above mentioned objects, the presented invention is constructed in the following manner. The System “DREAM OF LIFE” includes a special switch key, which is made of from two parts, part “A” and part “B”. The part “A” could be installed in the far part of tail in the aircraft in the special accomplished second cockpit, and be connected with all helms left-right, up-down. The connection to the contacts in part “A” make so that without part “B” all helms is off. Part “B” is consist: conductors located at the 45 angle between lines A-B; 24 pins go into holes in part A, diameter of ⅛ inches; switch-key, handle of which one can change position; part “B” goes into part “A” by 24 pins and holes. When situation at the board is normal handle of switch-key in left side and controlled with a green light. All management for airplane comes from main cockpit. When situation at the board abnormal, pilot in the second cockpit changes position for switch-key and now he takes care for flight, main cockpit is blocked.

### 4. MANUFACTURING

In this section of the report, we review and discuss the production requirements of the “DREAM OF LIFE”. At this point we are seeking and creating the largest potential manufacturing base possible. This includes producing the “DREAM OF LIFE” where applicable, in different materials, styles, sizes and shapes to better accommodate the various markets and their requirements. A large number of factors influence the production of a new product. Technology, material, labor and plant overheads are some of the key factors involved in arriving at a cost to produce a new product. Though the “DREAM OF LIFE” is not now in production, its characteristics are not unlike existing production methodology used today to manufacture similar products. Therefore, the production would be fairly straight forward, requiring no new technology.

The materials needed to produce the “DREAM OF LIFE” are considered to be “off-the-shelf” type materials. This simply means they are readily available, competitively priced and meet the standards set by the United States government, i.e., O.S.H.A., EPA, UL, etc. In today's environment, the materials used in factories are of considerable importance. With the public awareness of clean air and clean water, the laws governing these areas are strictly enforced. Manufacturers, especially in the plastics industry, are very cautious when it comes to using materials not already environmentally approved.

### DETAILED DESCRIPTION OF THE PREFERRED EMBODIMENT

FIGS. 1,2—Left and Right turn helms, Regular position

### Switch-Key Device

Green Light Control—Situation 1 handle of positions, switch in left side

1. Contact 1 and 0 connected together, Green light control—O.K. FIG. 1,2
2. Contact 1 and 0 connected together, Green light control—O.K.
3. Contact 1 and 0 connected together, Green light control—O.K
4. Contact 1 and 0 connected together, Green light control—O.K.

### Emergency Situation for Aircraft

FIGS. 3,4—Left-right helms

### Switch-Key Device in Emergency Position

RED LIGHT CONTROL—Situation 3 handle of switch position 3, key in right side

1. Contact 1 and 0 disconnected and 0 and 2 connected; red light control show emergency on the board.
2. Contact 1 and 0 disconnected and 0 and 2 connected; red light control show emergency on the board.
3. Contact 1 and 0 disconnected and connected to the 0 and 2; red light control show emergency on the board.
4. Contact 1 and 0 disconnected and connected to the 0 and 2; red light show emergency on the board and all management and control goes from second cockpit.

FIGS. 5,6—up and down helms, regular position, Green light control.

### Switch-Key Handle in Left Side, FIGS. 5-6

1. Contact 3 and 0 connected together
2. Contact 3 and 0 connected together
3. Contact 3 and 0 connected together
4. Contact 3 and 0 connected together
5. Contact 3 and 0 connected together
6. Contact 3 and 0 connected together
7. Contact 3 and 0 connected together
8. Contact 3 and 0 connected together

FIGS. 7,8—up and down helms, emergency position, Red Light control

### Switch-Key Handle in Right Side, FIGS. 7,8

1. Contact 3 and 0 disconnected and connected to the contact 0 and 4;
2. Contact 3 and 0 disconnected and connected to the contact 0 and 4;
3. Contact 3 and 0 disconnected and connected to the contact 0 and 4;
4. Contact 3 and 0 disconnected and connected to the contact 0 and 4;
5. Contact 3 and 0 disconnected and connected to the contact 0 and 4;
6. Contact 3 and 0 disconnected and connected to the contact 0 and 4
7. Contact 3 and 0 disconnected and connected to the contact 0 and 4
8. Contact 3 and 0 disconnected and connected to the contact 0 and 4 and all management and control goes from second cockpit.

Part “A” of the Switch-Key

This part has to be installed in the second cockpit—FIG. 9, which show line A-1 changed the direction at 45 degrees of angle from up to down. Line B-1 changed the direction at 45 degrees of angle from down to up. Line A-2 changed the direction at 45 degrees of angle from up to down. Line B-2 changed the direction at 45 degrees of angle from down to up. Line A-3 changed the direction at 45 degrees of angle from up to down. Line B-3 changed the direction at 45 degrees of angle from down to up. Line A-4 changed the direction at 45 degrees of angle from up to down. Line B-4 changed the direction at 45 degrees of angle from down to up. These changes make impossible to connect for hijackers. FIG. 9 show part A of Switch-key. Position 1—regular position; Position 2—power line; Position 3—emergency position. Now only lid of special Switch-key device can fixed this lines.

Part B of the Switch-key is a lid, which consist from longe one inch, 24 pins diameter of ⅛ inches and connected with a contact. The conductor of contact is located at 45 degrees of angle suitably to the conductor of part A. When is part B installed into the part A of Switch-key ready to work and aircraft ready too.

FIG. 6 show when handle of Switch-key in regular position, Green Light.

FIG. 7 show handle of Switch-key in Emergency position, Red Light.

### BRIEF DESCRIPTION OF THE ACCOMPANING DRAWINGS

FIG. 1-2 show a regular position for left and right helms, and schematic view.

FIG. 3-4 show an Emergency position for left and right helms and schematic view.

FIG. 5-6 show a normal position for up and down helms and schematic view.

FIG. 7-8 show an Emergency position for up and down helms and schematic view.

FIG. 9 show a part A of Switch-key where line A-B-1-8 group A1 coming to the Main cockpit in normal situation.

Line 1-8, group 0—power line.

Line C-D-1-8, group 2, these lines go to the second cockpit in an Emergency situation.

FIG. 10 approximate location of second cockpit.

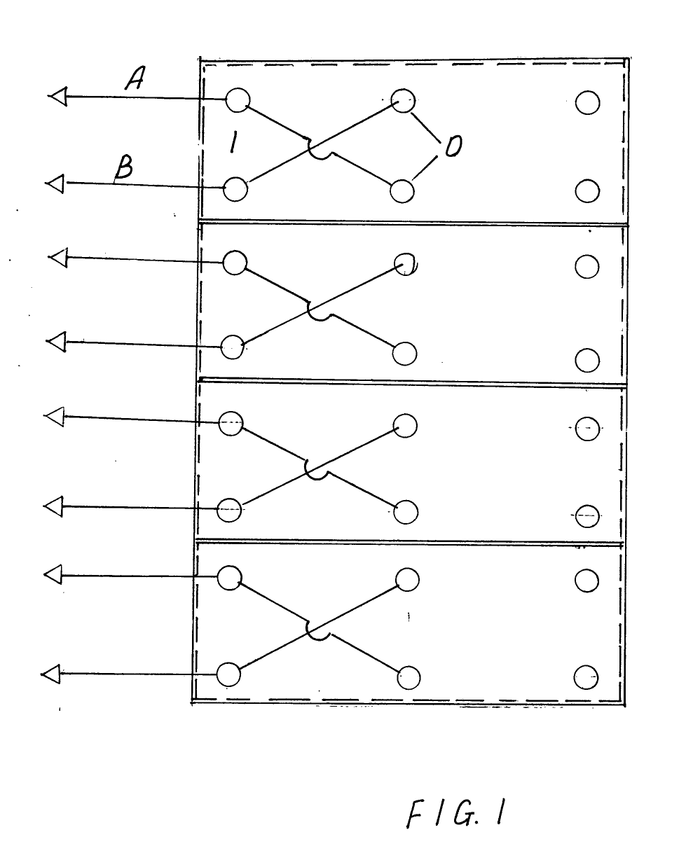

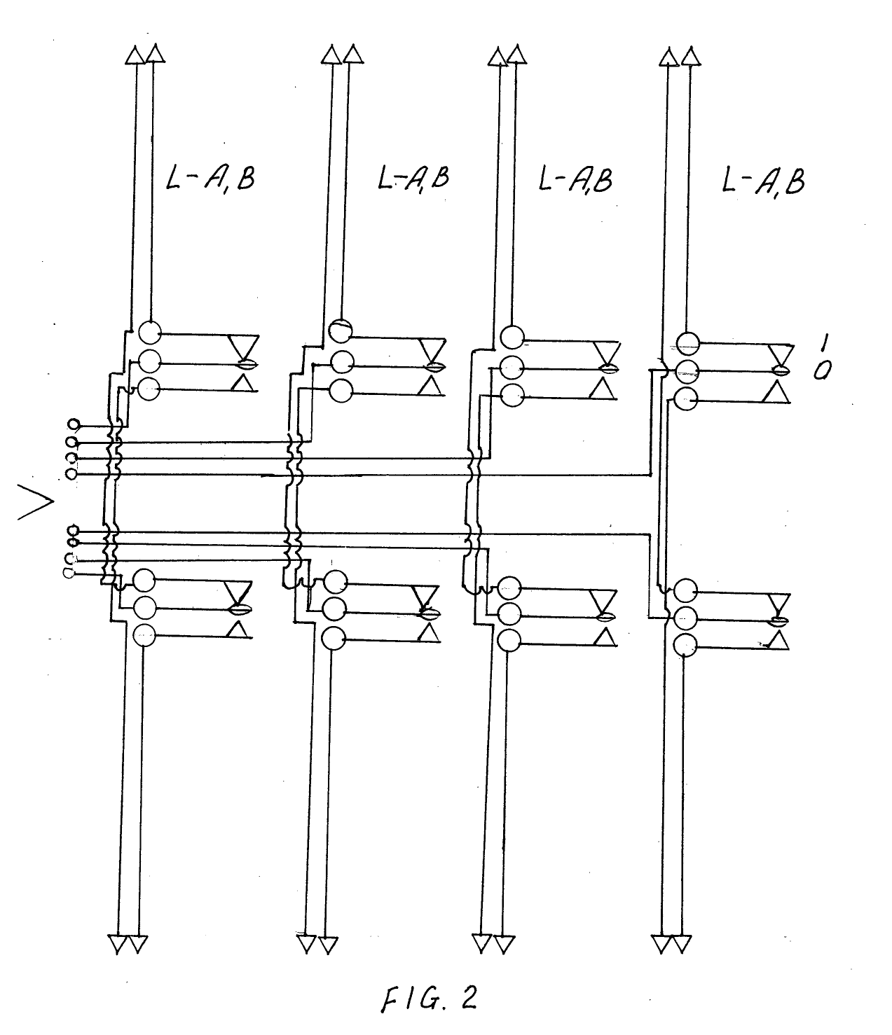

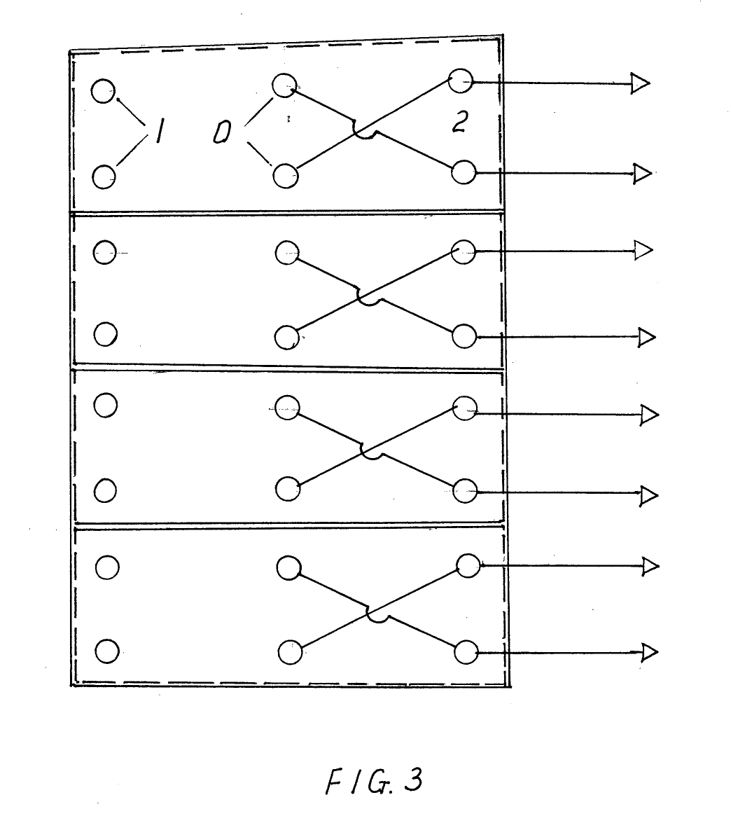

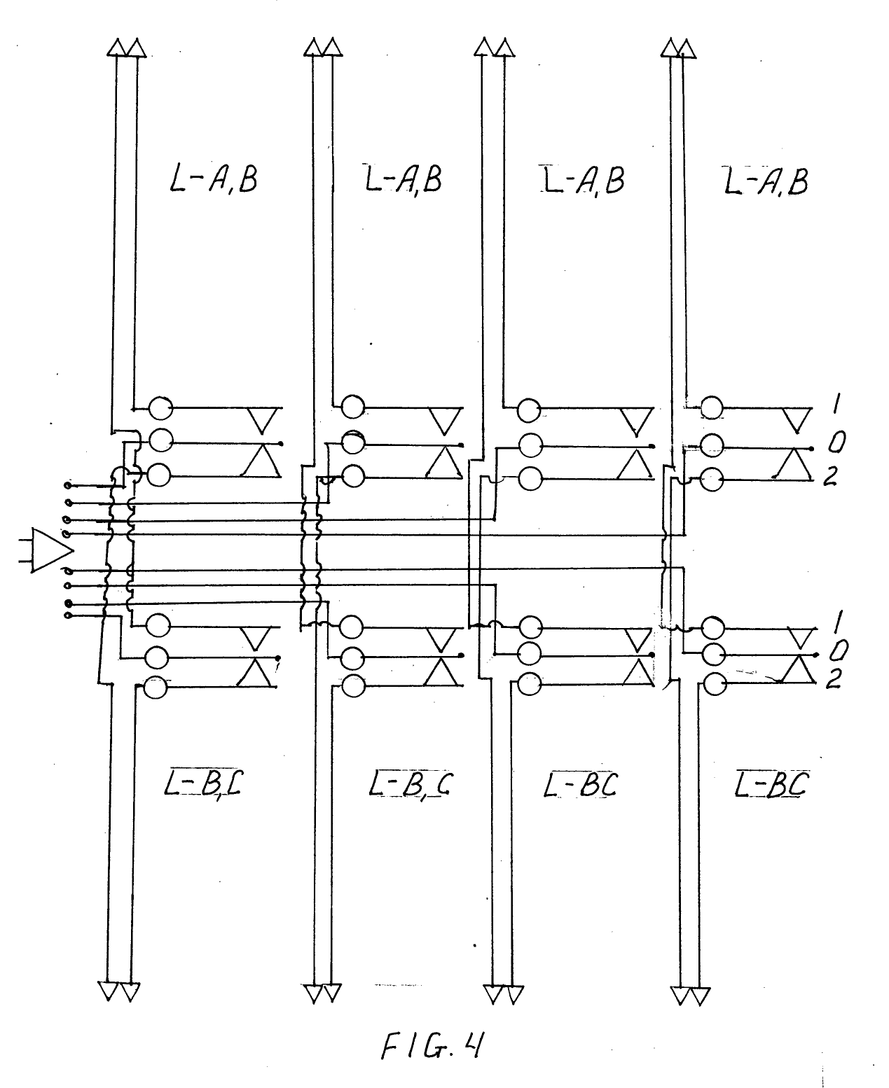

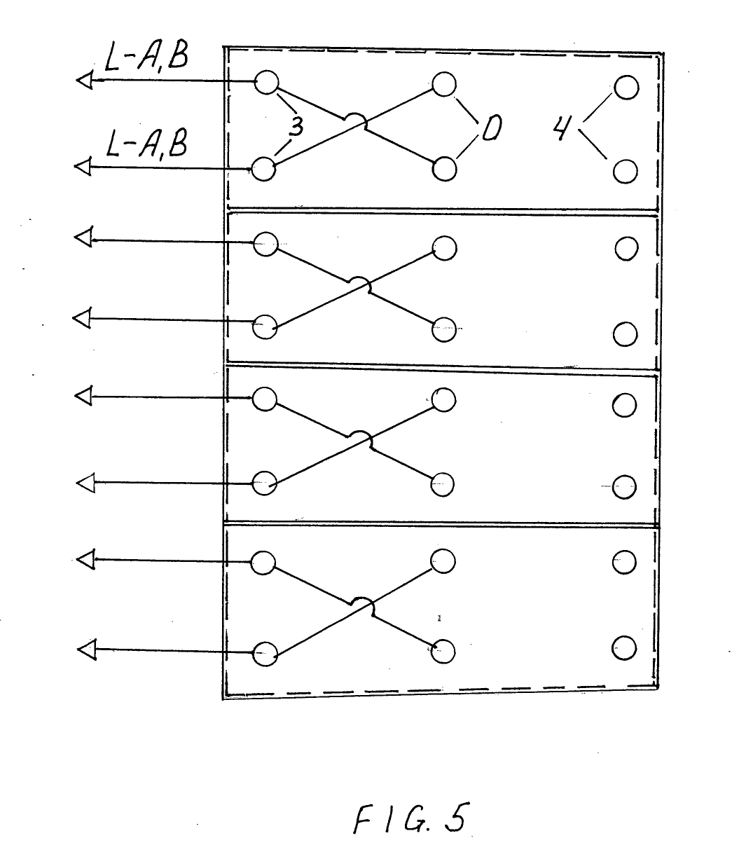

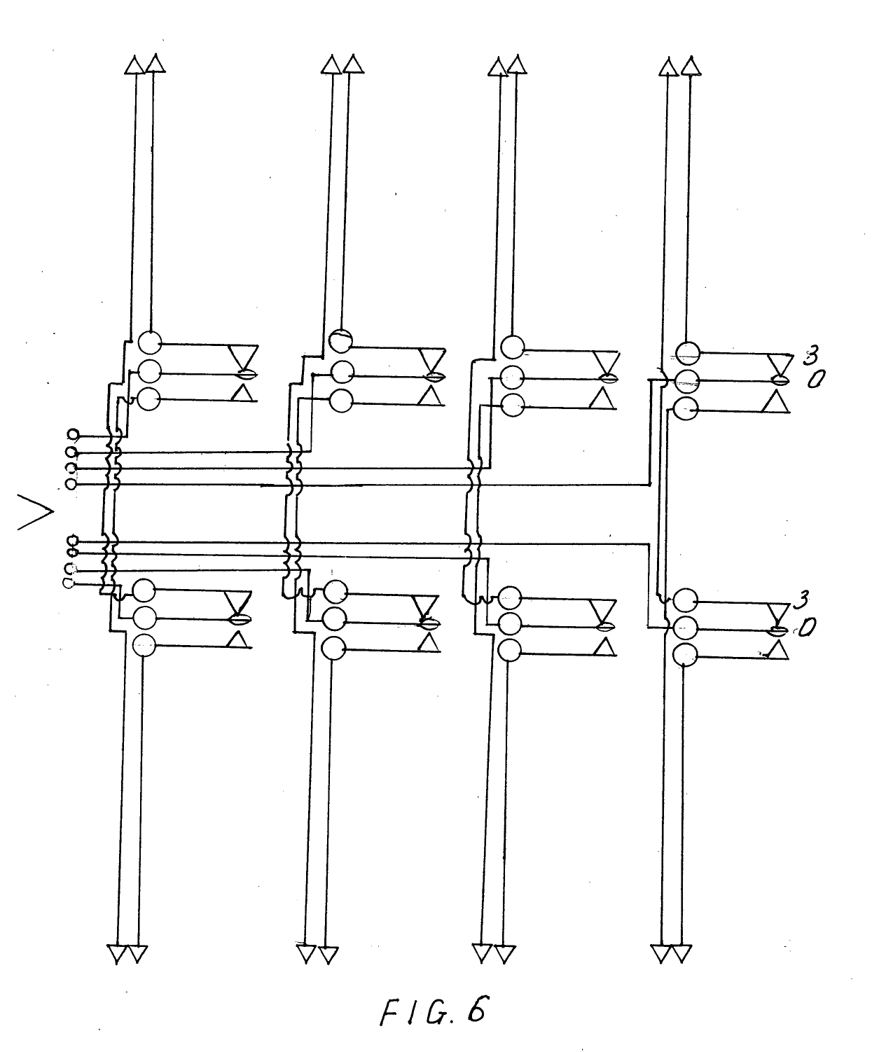

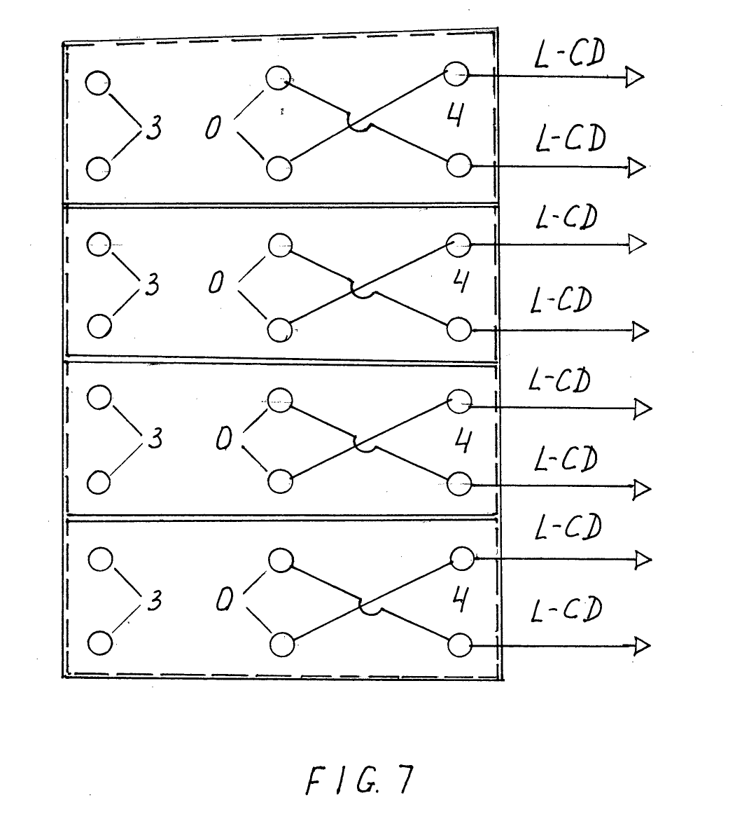

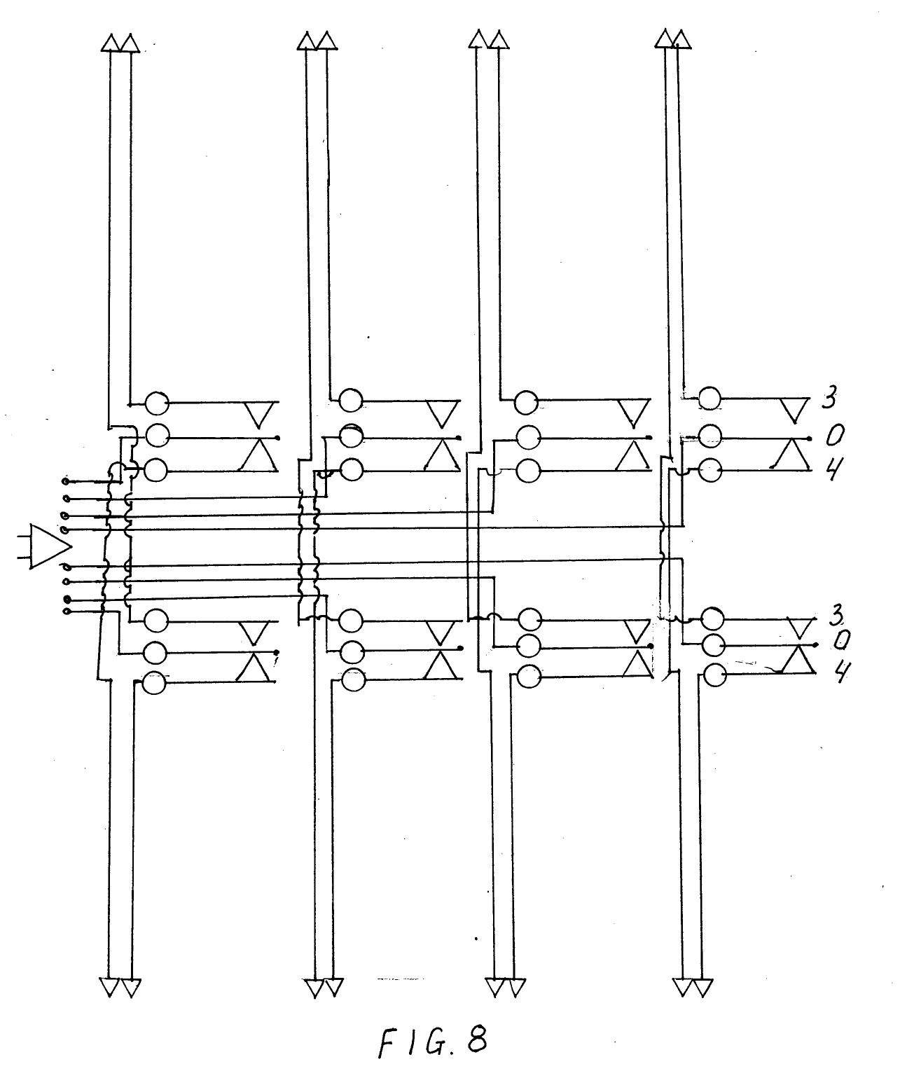

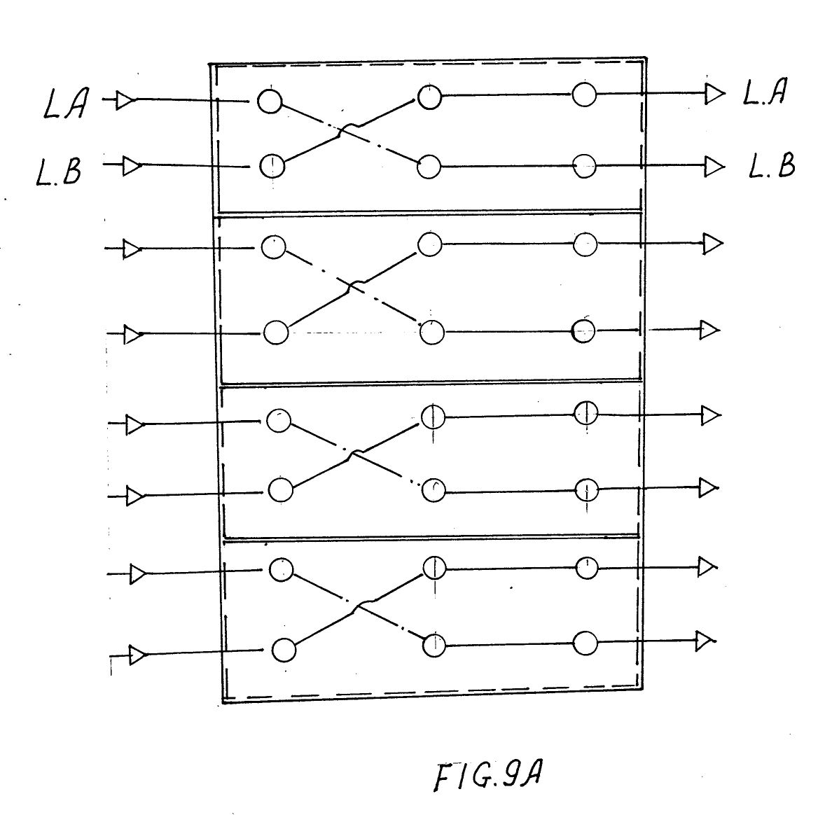

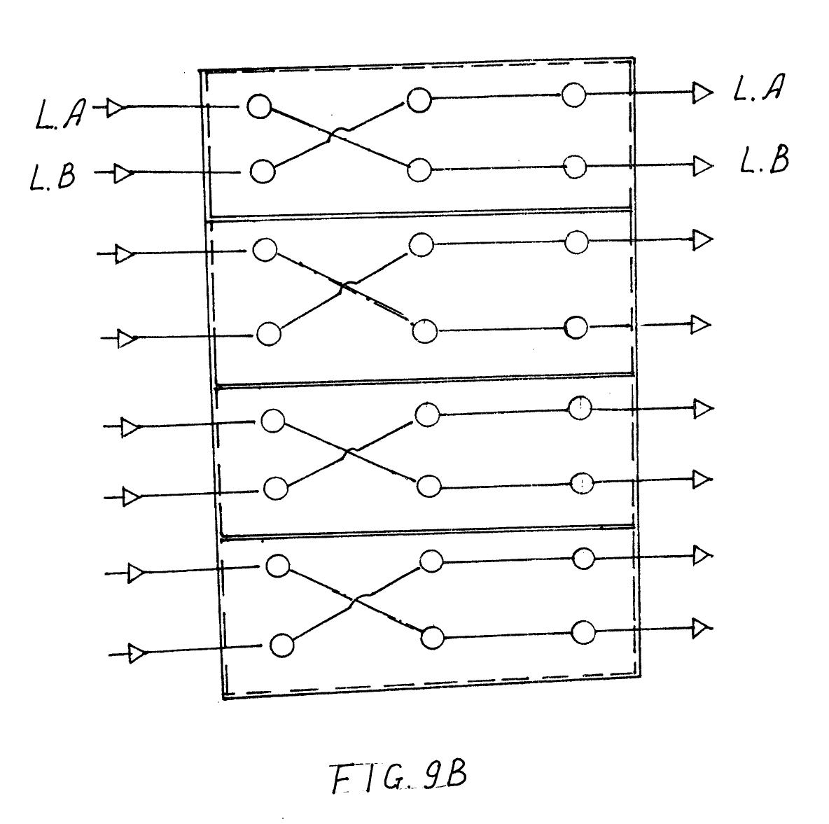

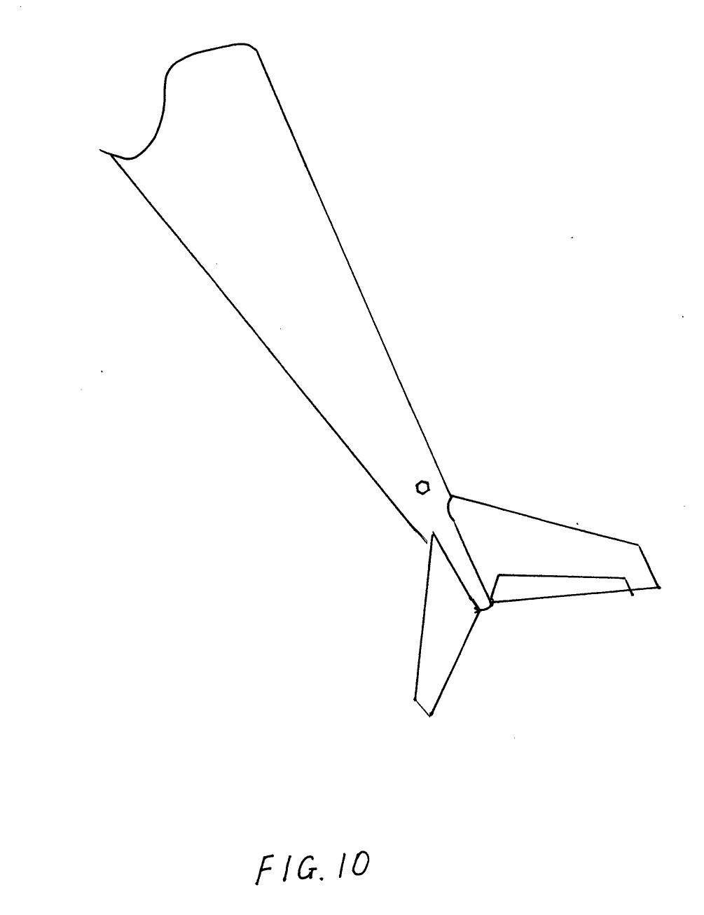

### OPERATOR

When an authorized people leaves this aircraft, they removed the lid of Switch-key. Contact elements A-1, B-8 of the first contact group are closed thereby breaking the power of the helms. When part B of Switch-key connected into part A, turning on the Switch-key in position 1, regular the power from group 1-8, through connected contact AB-1-8 conduct power into main cockpit. Turning on the Switch-key in position #2, emergency thereby breaking the power from group #2 to group #1, and destroyed helm in the main cockpit, and through contact group #1 to #3 accordingly connected power helm into second cockpit.

Foregoing description of the present invention “Dream of Life” demonstrates the Ability of the proposed this antiterrorism device, that could be successfully employed for prevention all hijackers. Although this description was done in connection with the preferred embodiment thereof it will be appreciated by those skilled in the art that some substitution or additions may be made without departing from the spirit and scope of the invention as defined in the appended claims.

1. The system “DREAM OF LIFE” is effective against hijackers and could save many passengers and crews life, and also prevents destruction of strategic objects on the ground. “DREAM OF LIFE” should be installed in every airplane and can prevent the hijackers from:
to forcing crew to change course;
to taking passengers as a hostages;
to threaten to explode or something else.
The hijackers in cockpit make all changes in direction as they want or they force the pilot to make the changes. All the instruments in the cockpit show the changes and continues on the original course or changes course for an emergency landing. The hijackers do not suspect any thing until the airplane has landed. They think that airplane is proceeding in their direction.

2. An the system “DREAM OF LIFE” according to claim, where is blocking a helms power from main cockpit have a special switch-key, which located in the special secure place, and could receive only by person who has a special training.

3. The switch-key in the system “DREAM OF LIFE” for aircraft according to claim 1, where is all conductor in contact group changed a direction at 45 degrees of angle this action make impossible to power an unauthorized person.

4. The switch-key in system “DREAM OF LIFE” according to claim 1, where is switch-key combined from two parts, part A which one could be installed in a secure place in tail of airplane and movable part B. Part A has round holes and part B has needles they are connected with a conductor for contact.

5. A switch-key of system “DREAM OF LIFE” for all flight, according to claim 3 have 2 parts and it activated only when part B into part A.

6. The switch-key according claim 1 where the selected elements contact group connected to two different place (main cockpit and second) with indicating control (Green, Red Light) and open or closed position of the power of helms.
